(19) United States
(12) Patent Application Publication
(10) Pub. No.: US 2012/0154401 A1
(43) Pub. Date: Jun. 21, 2012

(54) METHOD OF SIMULATING LIGHTING AT A POINT OF A SYNTHESIZED IMAGE

(75) Inventors: Julien CHAUVIER, Paris (FR); Nicholas PHELPS, Paris (FR)

(73) Assignee: E-ON SOFTWARE, Paris (FR)

(21) Appl. No.: 13/329,916

(22) Filed: Dec. 19, 2011

Related U.S. Application Data
(60) Provisional application No. 61/440,097, filed on Feb. 7, 2011.

(30) Foreign Application Priority Data
Dec. 17, 2010 (FR) 10 60741

(51) Int. Cl. G06T 15/06

(52) U.S. Cl. 345/426

(57) ABSTRACT

Simulating lighting at an estimation point of an image synthesized in three dimensions describing a scene provided with a light source, the estimation point situated on a surface. The method involves selecting a cloud of virtual photons by sending photons from the light source and by following the paths of the photons, each interaction with a surface of the scene potentially generating a new photon in the cloud, and storing a surface characteristic of the surfaces touched by the photon; and selecting a local volume of the photon map arranged around the estimation point. Additional steps can involve analyzing the photons contained in the local volume to detect the presence of at least one other surface different from the surface and extending in the vicinity of the estimation point; and calculating the indirect lighting at the estimation point while taking account of the at least one other detected surface.

The present invention relates to a method of simulating lighting at a point of a synthesized image.

### BACKGROUND OF THE INVENTION

In image synthesis, in order to simulate faithfully the natural lighting of a three-dimensional (3D) scene from light sources, such as the sun, it is practically essential to take account of the indirect illumination of objects, in particular in closed surroundings, where light interacts many times with the surrounding shapes, generating an indirect contribution that is not negligible, in the form of diffuse and/or specular inter-reflections.

Calculating the lighting of a point in 3D may be subdivided into two distinct components:
Direct lighting, representing the illumination of visible surfaces directly from light sources without intermediate interaction. The solid angle of the light sources from a 3D point is generally sufficiently small for the calculation of lighting and shading to converge at little cost, since the calculations are concentrated towards those specific zones. Ray tracing provides a robust method of calculating this direct contribution of sources on the 3D surfaces of a scene.
Indirect lighting, representing surfaces being illuminated after the light has interacted several times with other surfaces in the scene. Each 3D point can thus receive light coming from any other surface that is visible from that point, thereby making calculation extremely expensive since the calculation effort needs to be distributed (in general) over a solid angle that is much greater. The estimate therefore converges much more slowly, and ray tracing calculation rapidly becomes prohibitive for an accurate result.

In order to accelerate the calculation of indirect lighting, the photon mapping technique (sometimes called placing photons) was developed in the middle of the 1990s (“Global illumination using photon maps”, 1996, Henrik Wann Jensen) in order to generate an approximate solution for illumination in the form of a cloud of photons, prior to a final calculation of the image using ray tracing. The cloud forms the photon map. The cloud is generated by sending photons randomly from the light sources of the scene and by following their paths, each interaction with a surface generating a new point in the cloud, together with the local characteristics of the surface touched by the photon (position, incident direction of the photon, vector normal to the touched surface, light flux conveyed by the photon).

During final calculation of the image, rays are traced from the viewpoint in order to seek out visible surfaces in the image. At these points, direct lighting is generally evaluated via statistical ray tracing, thereby obtaining a Monte Carlo estimate for direct illumination. For indirect lighting, use is made of the photon map, by estimating photon density at the point under consideration. Dividing the sum of the fluxes from each of the collected photons by the area of the zone used for making the estimate then gives an estimate of the lighting at a given point.

If estimation is performed directly at points that are touched by the primary rays coming from the viewpoint, the “direct” photons (those touching the surfaces without intermediate interaction) must be ignored, since the direct lighting is calculated more accurately by ray tracing. If the estimation is performed at secondary points derived from hemispherical sampling by ray tracing, then all of the photons are taken into account.

The number of photons needed to produce a sufficiently accurate mapping of the lighting of a scene depends on its geometrical complexity, however a “mean” order of magnitude is about one million photons sent from the light sources, producing a photon cloud of several millions of photons.

That photon mapping method nevertheless presents certain drawbacks. Thus, while estimating lighting with the photon map, the photons in the vicinity of the estimation point are collected. This estimation point provides an indication of surface position and orientation in order to collect only photons that have similar properties. In FIG. 1, which illustrates the known photon mapping method, the estimation point P as represented by the cross indicates that the touched surface S is horizontal. Therefore, only photons of vertical normal and more or less in alignment with the touched surface are taken into consideration for estimation purposes. So-called “valid” photons are those that have surface position and orientation characteristics similar to those of the estimation point P, and so-called “invalid” photons are those that have surface position and orientation characteristics that are different from those at the estimation point P. In the traditional method of FIG. 1, the invalid photons are completely ignored.

The selection is represented symbolically by the circle that has been flattened along the normal at the touched point, to indicate that invalid type photons that might be placed on the vertical wall W will be ignored in the estimation, since they represent lighting on said wall W, and not on the horizontal surface S under consideration.

By its nature, the photon map is decorrelated from the initial geometry of the scene: it is constituted only by a cloud of photons, and therefore constitutes a spot sampling of the surfaces. In FIG. 1, it can be seen that the estimation point P is inside a room that is closed off by the wall W represented by the vertical line. Since density estimation requires some number of neighboring photons to be used that is sufficient for being statistically representative, the collection ray here passes through the wall W of the room and photons coming from outside lighting are taken into account in the estimation, thereby leading to an erroneous estimate of inside lighting close to the wall W. This “light leak” phenomenon is characteristic of the photon map and constitutes its major limitation. The photon map is “unaware” that a geometrical blocker, such as a wall, lies in the estimation zone, and it therefore does not restrict its estimation to the inside zone only.

FIG. 5 shows the direct visualization of the density estimate using the photon map in a room that has a visible end window, through which sunlight penetrates before illuminating all of the inside by multiple diffuse reflections. Light leaks can clearly be seen at the bottoms of the end and right-hand walls.

FIG. 6 shows the result after final calculation of the image, in which the photon map is used indirectly to estimate diffuse inter-reflections. The end and right-hand walls “see” the light leakage incorporated in the photon map, leading to an erroneous estimate for local lighting.

In order to overcome those drawbacks, it is generally necessary to trace numerous additional rays so as to detect the geometrical blockers, thereby reducing the performance of the method and considerably increasing its cost.

The article entitled “Improved Illumination Estimation for Photon Maps in Architectural Scenes” by R. Tobler and S. Maierhofer describes a prior art method of estimating illumination, making use of the ray-tracing method.

In order to overcome the above-mentioned drawbacks, it was initially envisaged to make direct use of the surrounding geometry. Nevertheless, that suffered from two major drawbacks:
it can operate only in the presence of polygonal geometry, with it not being easy to use any procedural geometry in order to limit the evaluation zone. That therefore greatly restricts circumstances in which the method can be applied, and departs further from photon mapping that specifically makes it possible for decoupling relative to the geometry of the scene to be complete; and
even in the presence of polygonal geometry, the process of locating the surrounding geometry is very expensive in terms of calculation, making it necessary to traverse the hierarchical tree of the scene in order to conserve only the geometry in the proximity of the evaluation point.

As suggested in the above-mentioned article by Tobler and Maierhofer, an indirect use of the surrounding geometry is also possible via geometry feelers: ray tracing is performed in a plurality of directions around the estimation point in order to detect potential surrounding blockers.

Nevertheless, major drawbacks remain:
the number of rays traced must be quite small in order to avoid a significant increase in calculation time, which can lead to problematic under-sampling of the local region; and
as with the preceding solution, in spite of a small number of traced rays, the calculations are very expensive and they are directly associated with the geometrical complexity of the scene, also compromising decoupling between the photon map and the geometry.

### OBJECTS AND BRIEF SUMMARY OF THE INVENTION

An object of the present invention is to overcome the above-mentioned drawbacks.

A particular object of the present invention is to provide a method that improves the photon mapping method, in particular by reducing or eliminating light leaks.

Another object of the present invention is to provide such a method that is simple and inexpensive to implement.

The present invention thus provides a method of simulating lighting at an estimation point of an image synthesized in three dimensions describing a scene provided with at least one light source, said estimation point being situated on a surface, said method comprising the following steps: selecting a cloud of virtual photons (photon map) by sending photons from said at least one light source and by following the paths of said photons, each interaction with a surface of the scene potentially generating a new photon in the cloud, and storing at least one surface characteristic of the surfaces touched by said photon; and selecting a local volume of said photon map arranged around said estimation point, the method comprising the following steps: analyzing the photons contained in said local volume to detect the presence of at least one other surface different from said surface and extending in the vicinity of said estimation point; said local volume contains “valid” photons having surface position and orientation characteristics similar to those of the estimation point, and “invalid” photons having surface position and orientation characteristics different from those of the estimation point, said method comprising making use of the invalid photons contained in said local volume to detect said at least one other surface in the vicinity of said estimation point, and calculating the indirect lighting at said estimation point while taking account of said at least one other detected surface.

Advantageously, at least one stored surface characteristic comprises one or more of the following characteristics: photon position; incident direction of the photon; vector normal to the surface; light flux conveyed by the photon.

Advantageously, the photons of the photon map that are situated, relative to said estimation point, on the other side of said at least one other detected surface are ignored during the steps of calculating the overall illumination of the estimation point.

Advantageously, the “invalid” photons of the photon map contained in the local volume are collected in order to perform statistical geometric reconstruction of said at least one other surface in the vicinity of said estimation point.

Advantageously, said step of analyzing the photons contained in said local volume comprises analyzing the local densities of valid photons, and using local discontinuities in photon density to detect said at least one other surface in the vicinity of said estimation point.

Advantageously, said step of analyzing local densities is performed by multiple partial density evaluations performed by subdividing the initial estimation surface into a plurality of subzones.

### BRIEF DESCRIPTION OF THE DRAWINGS

These characteristics and advantages and others of the present invention appear more clearly from the following detailed description thereof, made with reference to the accompanying drawings that are given as non-limiting examples, and in which:

FIG. 1 is a diagrammatic view of the prior art photon mapping method;

FIGS. 2 and 3 are diagrammatic views of a method in an advantageous implementation of the present invention;

FIG. 4 is a diagrammatic view of a method in a second implementation;

FIGS. 5 and 6 are diagrammatic views showing the results obtained with the prior art method; and

FIGS. 7 and 8 are diagrammatic views similar to FIGS. 5 and 6, showing the result obtained with the method of the invention.

### MORE DETAILED DESCRIPTION

An object of the present invention is to detect the presence of potential geometrical blockers within the density estimation zone in order to restrict photon collection—and also estimation area—to a geometrically connected zone around the initial estimation point. The term “geometrical blocker” is used to mean specifically a surface other than the surface on which the estimation point is situated, and that extends in the vicinity of said estimation point.

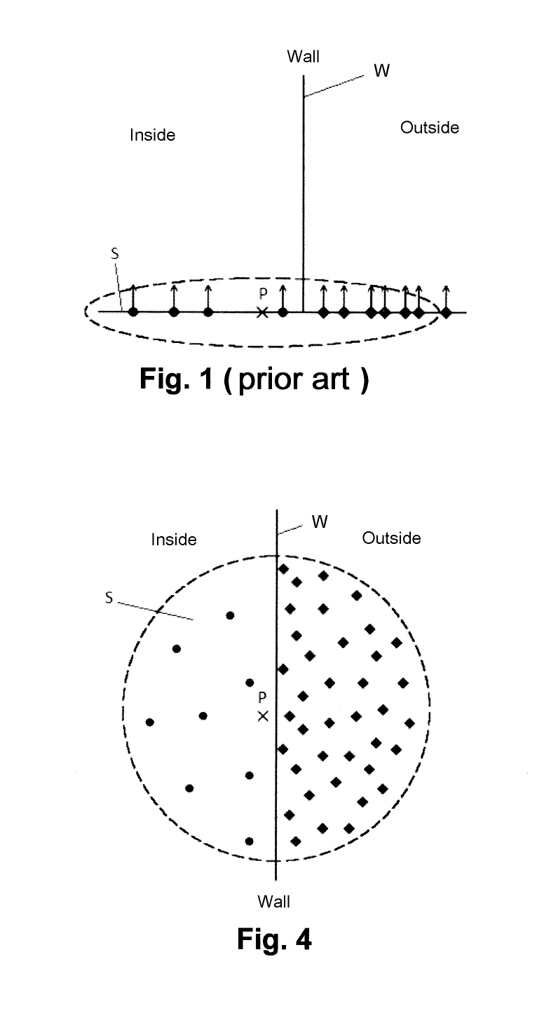

During conventional estimation as described above with reference to FIGS. 1, 5, and 6, photons adjacent to the estimation point P are collected, located in a local volume, typically a 3D sphere, approximately centered on the point P.

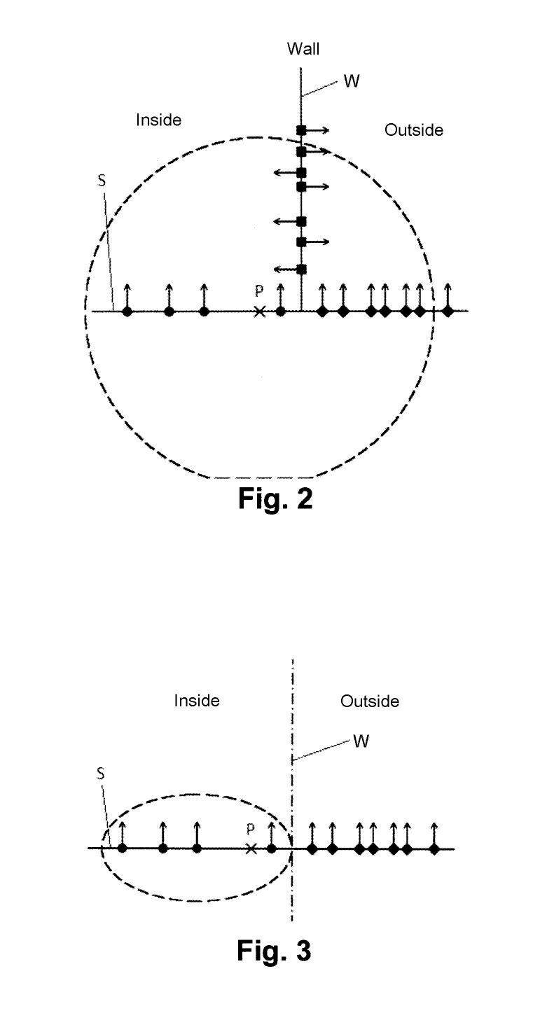

FIGS. 2 and 3 show an implementation of the invention. Numerous “invalid” photons that possess surface position and orientation characteristics that are too different from those of the estimation point P are ignored by the conventional photon mapping technique. However, those invalid photons contain important information about the local geometrical configuration. In FIG. 2, photons that the conventional method ignores are represented on the vertical wall W by squares. In this example their normal vector is perpendicular to the normal vector at the estimation point P and they therefore do not contribute to estimating lighting. However, they do constitute spot sampling of the wall. The estimation method of the invention collects all of these invalid photons in order to perform statistical geometrical reconstruction of blockers situated in the vicinity of the estimation point P. Unlike conventional photon mapping, which completely ignores so-called invalid photons contained in the sphere, the present invention uses these invalid photons to improve the calculation of illumination at the estimation point P.

Once this geometrical reconstruction has been performed, the “valid” photons collected for estimating the lighting are confronted with this geometry in order to determine whether they lie in a zone connected to the initial estimation point P. In FIG. 2, the outside photons represented by lozenges are ignored correctly. Estimation therefore takes place as shown in FIG. 3, without overflowing to the other side of the wall W.

While collecting photons suitable for participating in estimating local irradiance at a given point in the scene, the photons that are estimated to be “invalid” (not sufficiently in alignment with the point in question, and/or having normals that differ by too much) are stored temporarily.

They constitute point sampling of surrounding surfaces that might limit the local lighting zone geometrically. A diagrammatic example is shown in FIG. 3 where the photons deposited on the vertical wall are invalid for estimating the irradiance at the point P, but provide an indication of the presence of a geometrical blocker. This blocker indicates that the photons to the right thereof, even though in alignment with the point P and possessing similar normals, should be excluded from estimating irradiance at the point P.

Statistical reconstruction of geometrical blockers from a cloud of photons is described in greater detail below.

The reconstruction of the invention takes place in two stages:
classifying invalid photons in distinct groups having similar alignment criteria; and
determining a representative plane for each group containing sufficient photons for the data to be pertinent.

### 1) Classifying Invalid Photons:

Since the ultimate objective of the algorithm is to construct a series of planes representing an approximation to the local geometry at the estimation point, it is necessary to ensure that this representation is sufficiently accurate. Asymptotically, any continuous surface can be faithfully modeled by a tangential plane, providing the modeling area under consideration is small enough relative to the local curvature of the surface.

In order to ensure such accuracy, the classification zone may be subdivided uniformly into eight angular regions around the estimation point. Each invalid photon is then projected onto the plane determined by the estimation point and its geometrical normal, in order to determine the corresponding octant. Each octant is processed separately, thus making it possible to limit modeling error.

Once the octant has been determined, the photon is compared with the existing groups for said octant. If it is in alignment with one of the groups, then it is added to that group, otherwise a new group is created. The process continues until all of the listed invalid photons have been processed.

### 2) Determining the Plane Representative of Each Group:

Each group is constituted by photons that are aligned to a greater or lesser extent. All that remains to be done is therefore to determine a plane that is representative of the group. One possible method is orthogonal regression, given its robustness and its evaluation efficiency. The equation for the resulting plane thus minimizes the orthogonal projection distances of the points onto said plane.

In order to ensure a reconstruction that is statistically pertinent, only those groups that contain a sufficient number of points are conserved.

From conventional orthogonal regression results, the center of gravity of the points belongs to the looked-for plane, so it can be calculated simply and very fast. The quadratic form derived from the energy function that is to be minimized (the sum of the squares of the orthogonal projection distances) is then diagonalized in order to obtain its smallest eigenvalue and thus its associated eigenvector, which corresponds to the normal to the looked-for plane.

The collection of planes as established in this way makes it possible quickly to eliminate all candidate photons for evaluating irradiance that are not pertinent. Indeed, any photon placed on the other side of at least one of the planes relative to the evaluation point must be ignored, since it corresponds to illumination that is blocked by the local geometry.

The statistical reconstruction of the invention procures several advantages:
the solution by means of “geometry feelers” attempts to sample the geometry in the proximity of the evaluation point. The invalid photons that are conserved during the initial data collection provide this sampling without any additional calculation, thereby avoiding additional expensive calculations in order to obtain data that has already been calculated implicitly while constructing the photon map;
this data may be processed independently of the geometry of the scene, and thus independently of its complexity, thereby preserving this decoupling that is inherent to the photon mapping principle;
it follows that the method of the invention can be applied to any type of geometry initially supported by the underlying rendering engine, regardless of whether it is polygonal or procedural; and
the quality of the reconstruction naturally increases with the precision of the photon map, i.e. with the total number of deposited photons.

Another implementation is shown in FIG. 4. The valid photons may also provide information about the possible presence of geometrical blockers, in the form of local density discontinuities. The zone outside the plane of the floor, specifically the surface S, contains higher photon density since it is more exposed to sunlight. In this second implementation, these local density variations are used for detecting the presence of blockers. These local density variations can be detected within the lighting estimation zone by multiple partial density evaluations. One method of analyzing density consists in subdividing the initial estimation surface into a plurality of subzones, and then in calculating the local density for each of these subzones and comparing the local densities between subzones. These provide a map of local densities making it possible to detect discontinuities, if any.

FIG. 4 is a plan view of the initial scenario, i.e. an inside zone and an outside zone, separated from each other by a wall W. The dashed line circle symbolizes the local volume, specifically the initial estimation sphere. The density discontinuity boundary is an accurate model of the geometrical wall W between the inside and outside zones of the room.

Statistical analysis of the cloud of photons, whether on the basis of analyzing invalid photons as described with reference to FIGS. 2 and 3, or on the basis of fine analysis of local photon density, as described with reference to FIG. 4, makes it possible to completely eliminate light leaks in effective manner without having recourse to additional ray tracing for detecting neighboring blockers. The photon map on its own contains enough information about this effect, and the conventional estimation method provides a basis for the analysis methods of the present invention. In conventional photon mapping, invalid photons have already been identified, but they are ignored, and the local density discontinuities of valid photons are also ignored. The present invention thus simplifies the traditional method, and considerably reduces costs by avoiding having recourse to additional ray tracing.

FIG. 7 is a direct visualization of our new estimate of density by means of the photon map in the same scene as that shown in FIG. 5. No light leak is visible at the end and right-hand walls, and the quality of the estimation of local lighting is equivalent to that of the traditional method in zones that are not problematic. A comparison between FIGS. 5 and 7 shows clearly the improvement provided by the method of the present invention.

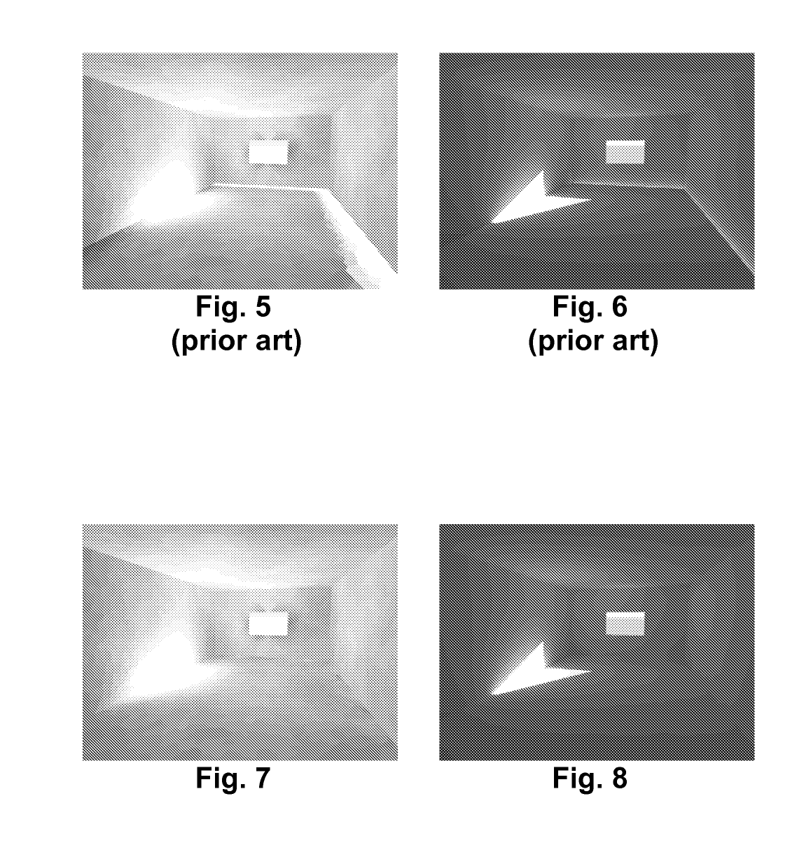

The same applies to FIG. 8, which shows the result of the final image calculation, in which the photon map is used indirectly to estimate the diffuse inter-reflections. Once more, the estimation method of the invention produces a result without visual error, unlike the result obtained with the prior art method, as shown in FIG. 6. Once more, a comparison between FIGS. 6 and 8 shows the effectiveness of the present invention.

Naturally, the present invention is also effective for modeling surfaces other than walls, e.g. objects, such as furniture, or other elements contained in the scene and capable of modifying overall lighting.

Although the present invention is described with reference to the implementations shown in the drawings, it should be understood that the person skilled in the art can apply any useful modifications without going beyond the ambit of the present invention as defined by the accompanying claims.

What is claimed is:

1. A method of simulating lighting at an estimation point of an image synthesized in three dimensions describing a scene provided with at least one light source, said estimation point being situated on a surface, said method comprising the following steps:
selecting a cloud of virtual photons (photon map) by sending photons from said at least one light source and by following the paths of said photons, each interaction with a surface of the scene potentially generating a new photon in the cloud, and storing at least one surface characteristic of the surfaces touched by said photon; and
selecting a local volume of said photon map arranged around said estimation point;
the method comprising the following steps:
analyzing the photons contained in said local volume to detect the presence of at least one other surface different from said surface and extending in the vicinity of said estimation point, said local volume contains “valid” photons having surface position and orientation characteristics similar to those of the estimation point, and “invalid” photons having surface position and orientation characteristics different from those of the estimation point, said method comprising making use of the invalid photons contained in said local volume to detect said at least one other surface in the vicinity of said estimation point; and
calculating the indirect lighting at said estimation point while taking account of said at least one other detected surface.

2. A method according to claim 1, wherein said at least one stored surface characteristic comprises one or more of the following characteristics: photon position; incident direction of the photon; vector normal to the surface; light flux conveyed by the photon.

3. A method according to claim 1, wherein the photons of the photon map that are situated, relative to said estimation point, on the other side of said at least one other detected surface are ignored during the steps of calculating the overall illumination of the estimation point.

4. A method according to claim 1, wherein the “invalid” photons of the photon map contained in the local volume are collected in order to perform statistical geometric reconstruction of said at least one other surface in the vicinity of said estimation point.

5. A method according to claim 1, wherein said step of analyzing the photons contained in said local volume comprises analyzing the local densities of valid photons, and using local discontinuities in photon density to detect said at least one other surface in the vicinity of said estimation point.

6. A method according to claim 5, wherein said step of analyzing local densities is performed by multiple partial density evaluations performed by subdividing the initial estimation surface into a plurality of subzones.
